(19) United States
(12) Patent Application Publication
(10) Pub. No.: US 2010/0179685 A1
(43) Pub. Date: Jul. 15, 2010

(54) METHOD, APPARATUS AND LOGISTICS SYSTEM FOR CARRYING A MAIL DISPATCH

(75) Inventors: Bernd Meyer, Konigswinter (DE); Jürgen Lang, Bergisch Gladbach (DE)

Correspondence Address: International IP Law Group, P.O. BOX 691927, HOUSTON, TX, 77269-1927, US

(73) Assignee: Deutsche Post AG, Bonn (DE)

(21) Appl. No.: 12/668,283

(22) PCT Filed: Jul. 9, 2008
(86) PCT No.: PCT/EP08/05594

§ 371 Date: Mar. 31, 2010

(30) Foreign Application Priority Data
Jul. 10, 2007 (EP) 07013466.3

(51) Int. Cl. G06F 7/00; G06F 17/00

(52) U.S. Cl. 700/227; 235/375; 700/230

(57) ABSTRACT

There is provided a method for conveying a mailpiece, whereby a first machine-readable code is applied onto the mailpiece as a data matrix code or stored in a transponder. An exemplary method comprises detecting the machine-readable code by at least one reading unit. The exemplary method also comprises applying a second machine-readable code onto the mailpiece as a linear code or storing the second machine-readable code in the transponder. The exemplary method additionally comprises storing information about a link between the first code and the second code in a data processing system. A service request is received and, depending on content of the service request, the service request is converted and forwarded to a provider server for a service.

### CROSS REFERENCE TO RELATED APPLICATIONS

Pursuant to 35 U.S.C. §371, this application is the United States National Stage Application of International Patent Application No. PCT/EP2008/005594, filed on Jul. 9, 2008, the contents of which are incorporated by reference as if set forth in their entirety herein, which claims priority to European (EP) Patent Application No. 07013466.3, filed Jul. 10, 2007, the contents of which are incorporated by reference as if set forth in their entirety herein.

### BACKGROUND

It is a known procedure to apply a machine-readable code onto mailpieces and to detect the machine-readable code while the mailpieces are being conveyed from an originating location to a destination.

WO 00/00300 puts forward a method for automatically or semi-automatically processing mailpieces, for example, letters or parcels, that are sent from a drop-off location to a destination. The mailpieces are transported in a first system in which a first address signal is detected that is contained in an address-identification object, for instance, in a barcode, in a printed or written address block or in an RF tag on the mailpiece. The address signal is processed and checked to ascertain whether it is sufficient for automatically sorting and distributing the mailpiece, whereby the possibility exists to derive an additional address signal and to apply it to the mailpiece. The mailpieces are then sorted according to their appertaining address signals. OCR and/or video systems are used to detect the identification data.

U.S. Pat. Appln. No. 2004/0215480 A1 discloses a shipping system for shipping packages involving the coordinated use of at least two carriers and that uses tracking information, billing information and other information for this purpose. The shipping system comprises physical delivery facilities that include at least one transfer location where the second carrier may take over delivery responsibilities for a package from the first carrier. The shipping system also includes an information system to check whether the delivery address of a package is a cost-effective destination for the first carrier. If this is not a cost-effective destination, the package is provided with a label for delivery to the transfer location, where it is transferred to the second carrier for purposes of the final delivery.

### SUMMARY OF THE INVENTION

Exemplary embodiments of the present invention relate to a method for conveying a mailpiece, whereby a machine-readable code is applied onto the mailpiece and whereby the machine-readable code is detected by at least one reading unit.

An exemplary embodiment of the present invention also relates to a device and to a logistics system for carrying out the method.

Exemplary embodiments of the present invention may allow detection and/or processing to be carried out reliably along the greatest possible part of the conveying route from the originating location to the destination.

An exemplary embodiment of the present invention comprises a method for conveying a mailpiece, whereby a first machine-readable code is applied onto the mailpiece, and whereby the machine-readable code is detected by a reading unit.

In an exemplary embodiment, a second machine-readable code may be applied onto the mailpiece, and information about a link between the first code and the second code may be stored in a data processing system.

An exemplary embodiment of the method, of the device and of the logistics system may be characterized in that the first code contains identification information.

In an exemplary embodiment of the method, of the device and of the logistics system, the second code contains identification information.

In an exemplary embodiment of the method, of the device and of the logistics system, the first code and the second code are applied onto the mailpiece in separate processing procedures.

An exemplary embodiment of the method, of the device and of the logistics system may be characterized in that the mailpiece is conveyed in the time between the application of the first code and the application of the second code.

The first code can be detected before, during and/or after the mailpiece has been conveyed. The detection of the first code makes it possible to perform one or more of the following functions:

Informing a user about the status of the shipment
informing a user about the status of the shipment,
controlling a processing procedure,
billing for the mailpiece.

The term “user” is to be understood in its broadest sense. In particular, it encompasses all entities that can enter into agreements to ship mailpieces. For example, these can also be software agents. However, natural or legal persons can likewise be included.

After the second code has been applied onto the mailpiece, the second code can be detected as well.

The detection of the second code likewise makes it possible to perform the above-mentioned functions
informing a user about the status of the shipment,
controlling a processing procedure of the mailpiece and/or
a billing procedure.

In conjunction with one or more of these functions, it may be possible to create a link between the first code and the second code.

Thus, for example, it is possible to provide a user of the mailpiece with information about the status of the shipment, making use of information associated with the first machine-readable code, especially the identification information contained therein.

Preferably, this is made possible for the user by making use of identification information.

In an exemplary embodiment of the invention, the identification information can be incorporated into the first code as well as into the second code and, if applicable, said identification information can be ascertained during a processing procedure of the mailpiece by detecting one of the two codes and, if applicable, making this available to the user.

An exemplary embodiment of the method, of the device and of the logistics system may be characterized in that the first code contains an identifier that distinguishes it from the second code.

In an exemplary embodiment of the method, of the device and of the logistics system, the second code contains an identifier that distinguishes it from the first code.

In this manner, a device for detecting a machine-readable code can be configured in such a way that it can easily and reliably ascertain whether the detected code is the first code or the second code.

In an exemplary embodiment of the method, of the device and of the logistics system, the first code is of a different code type than the second code.

According to an exemplary embodiment of the method, of the device and of the logistics system, the first code is a data matrix code.

In an exemplary embodiment of the method, of the device and of the logistics system, the second code is a linear code.

An exemplary embodiment of the method, of the device and of the logistics system may be characterized in that the first code is detected in a processing unit.

In addition, the second code may be detected in a processing unit.

In an exemplary embodiment of the method, of the device and of the logistics system, the first code is detected in a different processing unit than the second code.

An exemplary embodiment of the method, of the device and of the logistics system may be characterized in that a data record with data for identifying the mailpiece is created or modified, taking into account the identification information.

An exemplary embodiment of the present invention may provide for the use of a server that makes data about the mailpiece available to a user.

In an exemplary embodiment of the method, of the device and of the logistics system, the data record with the data for identifying the mailpiece is created or modified when the mailpiece is dropped off during the course of processing of the mailpieces.

In accordance with an exemplary embodiment of the present invention, the data record with the data for identifying the mailpiece, together with the detected graphic information that is present on the surface of the mailpiece, is stored on a server platform that is connected to the user terminal and to the processing unit.

In an exemplary embodiment of the method, of the device and of the logistics system, the data record or at least part of it is made available to a user.

An exemplary embodiment of the method, of the device and of the logistics system may be characterized in that the data record is stored on a server.

The server may make the data record available to the user.

In an exemplary embodiment of the method, the data record or at least part of it is made available to the user via a web-based configuration of the server.

An exemplary embodiment of the invention may be characterized in that the data record or at least part of it is made available to the user via an electronic notification.

In order to increase the data security, in one exemplary embodiment of the invention, it is provided that the data record or at least part of it is encoded and can be decoded for the user.

In accordance with an exemplary embodiment of the method, of the device and of the logistics system the data record is linked to information about the conveyance status of the mailpiece.

The term “conveyance status” also includes a conveying event such as, for instance, information about the detection, forwarding, transfer or delivery of the mailpiece.

An exemplary embodiment thereof provides that the data record comprises data about the status of the mailpiece, starting with the time when the mailpiece is dropped off at a drop-off location.

An exemplary embodiment thereof provides that the data record is modified, especially updated, during a subsequent detection of one of the codes for example, in a processing unit.

An exemplary embodiment of the method, of the device and of the logistics system may be characterized in that the conveyance status of the mailpiece is ascertained by detecting the first code.

In an exemplary embodiment of the method, of the device and of the logistics system, the conveyance status is ascertained, taking into account the detection of the second code.

The conveyance status may be ascertained, taking into account the link between the first code and the second code.

An exemplary embodiment of the method, of the device and of the logistics system may be characterized in that the first code can be detected by a first detection modality, and in that the second code can be detected by a different detection modality.

One of the detection modalities may comprise the detection of graphically depictable code constituents.

Examples of this are the detection of bars of a barcode or of modules of a data matrix code.

Moreover, one of the other detection modalities may comprise the detection of transponder signals.

The detection of the contents of the transponder may be performed by receiving electromagnetic signals from the transponder; in this case, code contents may be stored in a storage unit arranged in the transponder.

Many types of transponders are suitable for use according to an exemplary embodiment of the present invention. Special preference is given to transponders that serve as transmitting and/or receiving devices. In particular, these are receiving devices that, after receiving an external signal, are capable of transmitting a signal of their own.

Special preference is given to the use of transponders that are provided with at least one identifier. Below, such transponders are also referred to as RFID tags.

It may be possible to replace or augment a visually detectable identification of objects in transportation or logistics systems via RFID technologies involving transponders that can be written and read electronically multiple times. Such systems have the advantage that a great deal of information can be electronically written into and read out of a transponder, as a result of which automatic transportation, sorting, tracking or distribution procedures can be controlled without information having to be displayed visually.

A transponder with identifiers (RFID tags) may be configured as an RFID tag. An RFID tag includes a microchip and an antenna. A code containing processing-relevant information may be stored on the chip. In particular, this information may include identification information (ID).

Transponders may be configured in such a way that, in response to a triggering (radio) signal from a reading device, they themselves transmit and/or receive signals. Active transponders contain a source of energy for their operation. In contrast, passive transponders obtain energy from the signals transmitted by the reading device.

Through the use and targeted selection, an exemplary embodiment of the present invention comprises a logistics system that automates and considerably simplifies the transportation of objects to intended recipients.

Numerous types of reading devices are possible when transponders are used as a mechanism for relaying the measured values.

Antennas are used that are tuned to the specific wavelength of the electromagnetic radiation of the transponders.

The possibility of reading several transponders in rapid succession makes certain requirements of the reading unit that is going to be used.

The reading unit may be equipped with the BRM function known from the state of the art.

The BRM function (Buffered Read Mode=data filtering and data storage) helps to ensure that the data from transponders that have already been read out are buffered in the reader and is only read out once. This plays a role in applications with bulk recognition (anti-collision) since only “new” transponders are read out each time. Consequently, this increases the data transmission speed.

The information acquired in this manner is subsequently further processed.

Various transmission modalities can be employed for the transmission to the reading unit.

The reading unit may be arranged in a transportation mode for the mailpiece, in a warehouse or in a processing center for the mailpiece.

A data processing unit that can be in communication with the reading unit receives this status information from the reading unit.

In an exemplary embodiment of the invention, the position of the mailpiece is determined by a position-finding system that is in communication with the mailpiece, and the position of the mailpiece is associated with the identification information. In this case, the position of the mailpiece can be determined by a position-finding system directly on the mailpiece or on a transportation mode with which the mailpiece is being transported. If the position-finding system is situated on an appertaining transportation mode, it may be in communication with the transponder of the mailpiece.

The position of the mailpiece can be determined, for example, by a position-finding system in the form of a GSM module, a GPS module, and/or a direction-finding transmitter. The various position-finding systems can be used as a function of the required precision of the position determination.

An exemplary embodiment of the present invention relates to a device for processing mailpieces having a detector that is adapted to detect a first machine-readable code that has been applied onto a mailpiece.

An exemplary device may comprise a detector that is adapted to detect at least part of the first machine-readable code. The device may also have an applier that is adapted to apply a second machine-readable code onto the mailpiece, and an associator that allows a linking of the first code to the second code. The device may also be equipped with an interface for transmitting the linking information to a server.

In an exemplary embodiment of the method, of the device and of the logistics system, the logistics system has a conveyor that is adapted to convey a mailpiece to a device. The device comprises a detector that is adapted to detect at least part of a first machine-readable code and an applier that is adapted to apply a second machine-readable code onto the mailpiece. The logistics system comprises an associator that allows a linking of the first code to the second code, and a server that is configured in such a way that it can provide a data record for the identification of the mailpiece and/or information about the conveyance status of the mailpiece.

An exemplary embodiment of the method, of the device and of the logistics system may be characterized in that it comprises at least one device for processing mailpieces.

An exemplary embodiment of the method, of the device and of the logistics system may be characterized in that it comprises several devices, and in that the server is configured in such a way that it comprises a receiver that is adapted to receive information from the devices.

An exemplary embodiment of the method, of the device and of the logistics system may be characterized in that it comprises at least one device having a detector that is adapted to detect at least part of the first machine-readable code, in that it also comprises at least one device for detecting at least part of the second machine-readable code, and in that the server encompassed by the logistics system is configured in such a way that it comprises a receiver that is adapted to receive information from the first device and for receiving information from the second device.

An exemplary embodiment of the method, of the device and of the logistics system may be characterized in that it comprises at least two transport segments, and in that the first code is detected with a first detection modality in one transport segment, and in that the second code is detected with a second detection modality in another transport segment.

Moreover, the data record with the data for identifying the mailpiece may be created or modified when the mailpiece is dropped off during the course of processing.

An exemplary embodiment of the invention provides that the data record with the data for identifying the mailpiece may be created or modified in a processing unit for mailpieces.

The processing unit may be, for example, a machine that sets mail upright, a machine for sorting or a payment verification unit.

Such a setting machine is especially a device that is capable of arranging mailpieces in such a way that they can be introduced into a processing procedure of a subsequent additional processing unit in an especially simple and reliable manner. The setting machine is, for example, a device that sets several mailpieces upright one behind the other—preferably mailpieces of the same size. If necessary, the mailpiece can be turned in this process, so that the surfaces of the mailpieces on which graphic information is present are all oriented in the same direction.

Furthermore, it is possible for the processing unit to be a sorting machine.

Numerous types of sorting machines are known for sorting mailpieces—especially letters and parcels. An exemplary embodiment of the present invention may be used in conjunction with a detection of graphic information in a sorting machine that is configured in such a way that mailpieces can be fed to it via one or more feed chutes and can be ejected into containers at appropriate places after sorting procedures have been carried out.

The sorting is carried out, for example, in such a way that a discharge/outlet of the sorting machine can be associated with an intended delivery point.

Optionally, it is possible to carry out a payment verification and to use the result of the payment verification as another sorting criterion. In this manner, mailpieces that do not have the requisite postage to be conveyed can be diverted from the normal conveying route.

As a result, it is also possible to use the sorting device as a payment verification unit.

According to an exemplary embodiment of the present invention, however, the processing unit for mailpieces can, of course, equally well be a separate payment verification unit that is arranged upstream or downstream from a sorting machine or that is located somewhere else along the conveying route of the mailpieces. An exemplary embodiment of the present invention comprises the detection of the data record with the data for identifying the mailpiece when the latter is dropped off, when it is being conveyed as well as, if applicable, when it is delivered, for example, when it is given to a recipient in that it is dropped into a mail receiving means or in that it is specifically deposited, for example, into an optionally electronic mailbox facility or into an electronic parcel deposit box facility.

The data record or a part thereof can be made available to the user via a web-based server platform.

Moreover, the data record or a part thereof may be converted, if applicable, into another format and may be made available to the user via an electronic notification.

If applicable, the method is carried out or the system is configured in such a way that the data record or at least a part thereof is encoded and can be decoded for the user.

Furthermore, the data record or at least a part thereof may be made available to the user in a report and/or in an evaluation.

According to an exemplary embodiment of the invention, the data record comprises data about the status of the mailpiece, starting with the dropping off of the mailpiece at the drop-off location, whereby said data is modified, especially updated, by another processing unit.

For the sake of simplicity, the data for the identification of the mailpiece may be referred to below as identification information.

According to an exemplary embodiment of the present invention, the identification information is applied onto the mailpiece and is transmitted to a data processing unit.

The identification information can be used for billing and/or for processing the mailpiece.

A simple and uncomplicated generation of the identification information may be made possible for a user of the logistics system. In particular, it is possible to use identification information that comprises information that can be entered by a user and, if applicable, freely selected.

Exemplary embodiments of the invention provide for carrying out subsequent processing steps, taking into account the identification information. The identification information may be processed in the area of a server and/or in the area of the processing unit.

An exemplary embodiment of the present invention also relates to a server that is characterized in that it has at least one receiver that is adapted to receive a data record with data for identifying a mailpiece. It may interact with a storage device that is adapted to store the data record, and may be adapted to interact with a server platform that can make the data record or at least part thereof available to a user.

In an exemplary embodiment of the present invention, the server and/or the processing unit may be adapted to combine secure payment billing and/or payment verification (payment assurance) with simple handling of the mailpieces by the user.

The server can carry out functions for user rights administration, for administering postage fees and/or for billing purposes for franking services and/or directly for shipping services.

An exemplary embodiment of the method, of the device and of the system provides that the mailpiece is dropped off at a logistics system and that at least one processing step performed in the logistics system takes place as a function of the identification information.

This processing step may take place in the processing unit.

The positive list contains a directory of all mailpieces for which regular processing takes place within the logistics system, especially conveying them from a drop-off location to a delivery location.

An exemplary embodiment of the present invention also comprises a logistics system that automates and considerably simplifies the transportation of mailpieces to the intended recipients.

A system for processing a mailpiece may comprise the following components:
a receiving station for accepting the mailpiece,
a processing unit for recording graphic information that is present on the mailpiece,
a server platform for storing the data record with the data.

This system may be especially well-suited for carrying out the presented method.

According to an exemplary embodiment of the present invention, a logistics system is provided that is characterized by an especially high level of security and reliability, and that allows an especially simple and secure billing for the mailpiece.

The term logistics system is to be understood in its broadest sense within the scope of an exemplary embodiment of the present invention. It encompasses especially systems comprising mechanisms and devices for transporting mailpieces from drop-off locations to delivery locations via a transport route, preferably within a postal distribution network.

An exemplary embodiment of the method, of the device and of the logistics system may be characterized in that the identification information is stored and/or transmitted by a data processing unit that is coupled to a device that provides the mailpiece with the identification information.

This is done, for example, in that the data processing unit is connected to a printer that prints the identification information onto the mailpiece. However, by the same token, it is possible to provide the printer with a writing unit for writing onto an electronic data carrier, for example, a transponder. Such a writing procedure can be carried out, for example, contact-free by electromagnetic signals.

An exemplary embodiment of the invention provides that the identification information is printed onto the mailpiece.

An exemplary embodiment of the invention may be characterized in that the identification information is applied onto an information carrier that can be attached to the mailpiece.

The information carrier can be configured, for example, as a sticker. Moreover, it is possible for it to be a constituent of the shipment, for example, in that the identification information is printed onto a letter placed into the mailpiece.

Billing for the mailpiece is possible through the acquisition of identification information that has been applied onto the mailpiece.

If an acquisition of the identification information applied onto the mailpiece or attached to the mailpiece is carried out in the area of a processing unit, it is advantageous to associate the identification information with billing-relevant data.

Billing-relevant data includes especially information about the sender, the recipient, the dimensions and weight of the mailpiece as well as about the services requested by a particular user such as, for example, special delivery.

An exemplary embodiment of the invention provides for obtaining this information on the basis of the identification information.

Another exemplary embodiment of the invention comprises a determination of the shipment-relevant data by checking the mailpiece, for example, by optical character recognition.

An exemplary embodiment of the invention provides for carrying out billing in a way that takes into account ascertained values regarding the weight and/or the dimensions of the mailpiece.

This can be done, for example, in the area of the processing station.

However, by the same token, it is possible to carry out billing on the basis of the transmitted identification information.

In the case of billing that takes into account the transmitted identification information, it is possible, for example, to take into consideration information about the shipment that has been entered by the individual user, especially information about its mail category (product category), for example, standard letter or parcel, weight, dimensions, additional services such as proof of delivery, special delivery, timed delivery, insurance, COD or CO₂-neutral transportation, the applicable values for the shipment size and/or shipment weight.

There are various billing options in conjunction with an evaluation of the electronically transmitted identification information.

The specific billing can be carried out on the basis of an agreement between the logistics company and the user and/or on the basis, for example, of published terms and conditions of use of the logistics company, also for unregistered users.

Especially in the case of registered users, it is advantageous for the registered users to transmit billing-relevant data such as, for example, the mail category or the applicable transportation modality, along with the pertinent identification information about a mailpiece.

The mail category and/or the transportation modality can be detected in the area of an appropriately retrofitted franking machine so that, for example, weight determination functions of the franking machine can be used.

Moreover, in this manner, a direct association between the determined weight and the mailpiece is possible in that a connection is made between the process steps of ascertaining the shipping data and applying the identification information.

A combination of the method steps of ascertaining the shipping data and applying the identification information makes it especially easy to acquire this data concurrently.

This facilitates the subsequent transmission of the identification information and of the optionally associated shipping data and/or billing data to the server.

The transmission can be done, for instance, directly by the franking machine and/or by a user computer. For example, this is the transmission via a suitable data line such as, for example, a telephone connection or an Internet-based connection.

An exemplary embodiment of the method, of the device, of the server, of the logistics system and of the processing unit may be characterized in that, if the identification information is stored in a positive list, the mailpiece is further processed.

The positive list is a list that can be drawn up for payment assurance reasons. It contains information about mailpieces that have been accepted for conveyance. Moreover, the positive list can also include users for whom forwarding of the mailpieces has been specified.

The use of a positive list has the advantage that, in this manner, it is possible to prevent the risk of fraudulent use of the logistics system for mailpieces for which insufficient payment or no payment at all has been made.

According to an exemplary embodiment of the present invention, however, it is likewise possible to use other measures for payment assurance such as, for example, checking known security features such as the validity of the digital information or the authenticity of the postage indicia.

In an exemplary embodiment of the method, of the device, of the server, of the logistics system and of the processing unit, the further processing comprises the transportation of the mailpieces to an intended destination.

An exemplary embodiment of the method, of the device, of the server, of the logistics system and of the processing unit may be characterized in that the identification information contains information about the identification of a user.

An exemplary embodiment of the method, of the device, of the server, of the logistics system and of the processing unit may be characterized in that the user is registered in an authorization system.

An exemplary embodiment of the method, of the device, of the server, of the logistics system and of the processing unit may be characterized in that, after registration in the authorization system, an access authorization is granted to the user so that he/she can transmit the identification information to the data processing unit.

An exemplary embodiment of the method, of the device, of the server, of the logistics system and of the processing unit may be characterized in that, in addition to the information for identifying the user, the identification information contains additional information.

An exemplary embodiment of the method, of the device, of the server, of the logistics system and of the processing unit may be characterized in that an input device is provided that allows the additional information to be entered, at least partially, by the user.

An exemplary embodiment of the method, of the device, of the server, of the logistics system and of the processing unit may be characterized in that the additional information contains a number. This can be a consecutive number, which facilitates the billing. The use of consecutive numbers is advantageous, but not necessary.

In an exemplary embodiment of the method, of the device, of the server, of the logistics system and of the processing unit, in a processing procedure of the mailpiece, the identification information is deleted from the positive list.

An exemplary embodiment of the method, of the device, of the server, of the logistics system and of the processing unit may be characterized in that the mailpiece is diverted from a normal conveying route of the mailpieces if the identification information is not stored in the positive list.

In an exemplary embodiment of the method, of the device, of the server, of the logistics system and of the processing unit, the identification information transmitted to the server is used for billing purposes for the mailpiece.

An exemplary embodiment of the method, of the device, of the server, of the logistics system and of the processing unit may be characterized in that identification information applied onto the mailpiece is used for billing purposes for the mailpiece.

In an exemplary embodiment of the method, of the device, of the server, of the logistics system and of the processing unit, the transmitted identification information is reconciled with the identification information applied onto the mailpiece.

An exemplary embodiment of the method, of the device, of the server, of the logistics system and of the processing unit may be characterized in that information for billing purposes for the mailpiece is transmitted to the servers.

An exemplary embodiment of the method, of the device, of the server, of the logistics system and of the processing unit may be characterized in that information for billing is acquired, taking into account additional information associated with the mailpiece.

An exemplary embodiment of the method, of the device, of the server, of the logistics system and of the processing unit may be characterized in that billing-relevant data is acquired by checking physical properties of the shipment.

An exemplary embodiment of the invention comprises billing on the basis of the transmitted identification information and/or billing on the basis of the shipping data acquired together with the identification information.

An exemplary embodiment of the method, of the device, of the server, of the logistics system and of the processing unit may be characterized in that the franking unit has a generator that is adapted to generate identification information. The device is also adapted to provide mailpieces with the identification information, and also contains a transmitter that is adapted to transmit the identification information to a network node.

In an exemplary embodiment of the method, of the device, of the server, of the logistics system and of the processing unit, the processing unit has acquisition device that is adapted to acquire identification information associated with the mailpieces. The processing station is also adapted to check whether the identification information is stored in a positive list.

An exemplary embodiment of the method, of the device, of the server, of the logistics system and of the processing unit may be characterized in that it comprises a device that is adapted to divert mailpieces from a conveying and/or processing procedure of the mailpieces.

An exemplary embodiment of the method, of the device, of the server, of the logistics system and of the processing unit may be characterized in that the logistics system has a receiver that is adapted to receive electronically transmitted identification information and to store the identification information in a positive list, in that the logistics system also has a device that is adapted to check identification information applied onto mailpieces, and in that the logistics system has a device that is adapted to check whether the identification information applied onto the mailpieces is stored in the positive list.

The identification information and, if applicable, the billing-relevant information can be applied onto the mailpiece in various ways. In particular, it is possible to use conventional methods for printing mailpieces.

The method may comprise a method for printing that makes use of printing systems that apply a matrix code onto mailpieces and that retain transaction data until it is transmitted to the central system. Replenishing postage in advance is not necessary. The billing can be done daily after the fact via an interface between the machine and the order management system. Here, the information is transmitted from the matrix code (user number, order number, shipment number) to the order management system and used there for the further checking and billing.

An exemplary embodiment of the invention provides for making information available to a user, for example, via a website.

For example, the data record pertaining to the mailpiece is generated when the mailpiece is dropped off and/or franked, and it is provided with a shipment number. The data record can comprise a “status” field that is set to “dropped off” once the mailpiece has been dropped off.

The shipment number can be present in the form of a code, and the recipient address can be detected as part of the graphic information, for example, by OCR (Optical Character Recognition). The data record pertaining to the mailpiece is ascertained on the basis of the shipment number, and the detected recipient address is added to the data record. A web server then receives the information about the recipient address contained in the data record and displays it on an appropriate website.

In any case, it is important for data and/or information about a mailpiece to be acquired so that, on that basis, at least one piece of information is determined that identifies the mailpiece and/or the person dropping off the mailpiece. The shipment number is especially well-suited for this purpose, although other data for the identification is also conceivable.

The data record may be stored in a so-called customer data management system (KDM). The data record can then also be used at a later point in time, for example, for service billing by a postal service provider.

In an exemplary embodiment of the method, it is provided for the data record or parts thereof to be made available to the user via a web-based server platform.

By the same token, it may be advantageous for the data record or parts thereof to be converted into another format, if applicable, and then made available to a user via an electronic notification.

An electronic notification can especially be transmitted via a so-called push process. Examples of this are e-mail, SMS (Short Message Service), MMS (Multimedia Messaging Service), Skype (Internet telephony) and Instant Messaging (so-called “chat”).

The format of the data record or parts thereof can be converted for various reasons. However, in particular for the transmission of an e-mail, SMS or the like, it is necessary, for example, for digital image data to be converted into a simple text format.

In another advantageous configuration of the method, the data record or parts thereof may be encoded and can be decoded for the user.

In this manner, it is ensured that only an authorized user has access to the data of a mailpiece.

In actual practice, encoding takes place, for instance, in such a way that a shipment number is applied onto the mailpiece as a code. The so-called “postal matrix code” has especially proven its worth in this context.

This code is a two-dimensional code that, in comparison to one-dimensional barcodes, has a much higher information density per unit of surface area. Moreover, the postal matrix code is also suitable for the franking of a mailpiece and it is subject to a standard.

Another exemplary embodiment of the method provides that the data record or parts thereof are made available to a user in a report and/or in an evaluation.

Particularly business customers have an interest that the data about the mailpieces in circulation be displayed in a specially prepared manner. This preparation can be, for example, a breakdown according to different recipient addresses, according to the shipping status, the delivery data and the like.

It may be advantageous for the data record to comprise data about the status of the mailpiece, starting with the acceptance of the mailpiece at the receiving station. This data about the status can be modified, especially updated, by another processing unit. As soon as a mailpiece reaches prescribed stations along its conveyance route, for example, an appropriate code that is located on the mailpiece is scanned and the status is updated accordingly in the data record. A web server has access to the data record and displays the updated contents to a customer on a website.

The graphic information advantageously comprises information about an addressee of the mailpiece.

The graphic information is preferably detected by a scanning device.

A scanner serves, for example, to read in the address and, depending on the type of scanner, the read-in information is transmitted by radio or by cable. In this context, it is common practice to use radio scanners with a multi-line display and an output possibility as well as a touch screen and/or a keyboard with a rudimentary input function.

In various scanners, a so-called scanner-controller component is often used that constitutes an interface between the scanners and the other components of a system and that administers incoming matrix codes of various scanners for further processing at different places at different points in time.

In general, it is advantageous to associate the various types of graphic information on the surface of a mailpiece with specialized reading devices. Here, the graphic information can be acquired by a central image processing device that supplies the specific reading devices with digitized information via standardized interfaces.

Examples of specialized reading devices are devices that ascertain the encoding contained in the graphic information by deciphering the code. For instance, such specialized reading devices serve to acquire information from digital postage indicia in the above-mentioned postal matrix code.

An additional exemplary embodiment of the method is characterized in that the graphic information located on the surface of the mailpiece and acquired at the processing unit is examined by an image processing device so as to ascertain whether the acquired graphic information differs from prescribed graphic information and, if it differs, a notification is generated at the user terminal and at the processing unit.

Here, a processing center for mailpieces can comprise several central image processing devices or else a central image processing device can process the graphic information of several mail or freight centers.

Moreover, the graphic information present on the mailpieces can be processed sequentially as well as simultaneously by an image processing device. In particular, it is advantageous to carry out the method using the image processing device in such a way that the available image processing capacities are used as efficiently as possible by effectively distributing the image processing tasks among several components of a central image processing device.

The term image processing, especially the image processing device, should not be construed as a limitation in any way whatsoever. In particular, the term encompasses the transformation of the graphic information into additional graphic information, for example, the conversion into another format, the forwarding of the graphic information and/or the evaluation of additional information contained in the graphic information and/or obtained from the graphic information, such as reading a recipient address or deciphering information that is contained in encoded form in the graphic information. Moreover, the term of image processing also includes the features that are sometimes referred to in the realm of image processing as image interpretation. This also includes, for instance, the deciphering of recipient addresses by reading the graphic information that graphically depicts the recipient address, for example, in the form of handwritten information.

An exemplary embodiment of the present invention may process a mailpiece employing one of the above-mentioned methods, comprising the following components:
a receiving station for accepting the mailpiece,
a processing unit for acquiring graphic information that is present on the mailpiece,
a server platform for filing the data record with the data for identifying the mailpiece and with the acquired graphic information present on the mailpiece, whereby said server platform is connected to a user terminal and to the processing unit, and it makes data and/or information of the data record available to a user.

The receiving station can be, for example, a mailbox, a terminal at a counter, an electronic parcel deposit box facility or a drop box.

### BRIEF DESCRIPTION OF THE DRAWINGS

The figures show the following:

FIG. 1 is a block diagram of an exemplary embodiment of the present invention; and

FIG. 2 is a block diagram of a device according to an exemplary embodiment of the present invention.

### DETAILED DESCRIPTION OF SPECIFIC EMBODIMENTS

Below, a preferred embodiment of the invention will be presented with reference to the forwarding of mailpieces via mailpiece distribution networks of two different logistics companies.

Of course, it is likewise possible to implement an exemplary embodiment of the present invention within a single logistics company.

Since the use of an exemplary embodiment of the present invention in a combination of at least two different logistics systems is especially preferred, this implementation will be described below.

For example, it is possible to print a linear code together with a two-dimensional (postal matrix) code onto the mailpiece and, as an alternative to this, to create a link between the postal matrix code and a linear code that was added at a later point in time.

This is convenient for national as well as international shipments, depending on the infrastructure that is present in each case for the detection of the codes, since the invention can be used for the national as well as international shipment of mailpieces.

In the case of national mail services, the processing can take place on the basis of the applied postage indicia and of the contents of the machine-readable postal matrix codes. It is not necessary to comply with international conventions for additional mail services (e.g. linear barcode) since the processing takes place within one's own production and delivery network.

In the case of international additional mail services, in contrast, it is necessary to comply with international conventions so as to offer other postal service providers unambiguous interfaces in the form of linear barcodes, number sets, checksums, etc.

In order to avoid having to generate alternative postage indicia for national and international products in all franking systems in the case of international additional mail services and in order to optimize customer-friendliness and efficiency, the invention comprises a device that can detect the first code and can generate a second code in such a way that a link is made possible between the first code and the second code.

When the invention is used in international mail traffic, this is made possible, for example, in that—in a logistics center provided for international transportation, for example, an existing international mail center—international designations that are suitable for all franking modalities are applied and are linked electronically to the nationally used franking ID. This method will be referred to below as “relabeling”.

Through this method of central relabeling, it is possible to avoid, on the one hand, numerous special processes for the individual franking modalities and, on the other hand, other error risks for the customer.

With the execution of the method according to the invention, it is advantageous to carry out individual, several or all of the following process steps:
Franking with international additional mail services are franked in the same manner as national additional mail services.
As is the case with national shipments, the franking ID (consisting of two ten-digit character strings) is used as the identification information.
As is the case with national shipments, the premium services are described in plain text in a language of the first logistics company.
The shipment is dropped off and transported to the international mail center (IPZ).
The shipment is read in the international mail center. Here, the desired shipping product as well as the franking ID are determined on the basis of the postal matrix code.
As a function of the encompassed international additional mail services, a suitable label is applied having an independent shipment number in a linear barcode and plain text designation according to international agreements. The shipment is subsequently ready to be shipped internationally.
In a central data processing system, the shipment number of this applied label is linked to the previously read identification information of the franking.
Foreign postal service providers process the shipment on the basis of the (only available) linear barcode.
Status information from abroad, based on the ID of the linear code, is transmitted to the German postal system, the Deutsche Post.
In the data processing system, the foreign status information is associated with the national franking IDs.
The customer can initiate a tracking and tracing query with the national franking ID, using international shipment tracking, without any knowledge of the BZL-ID used abroad.

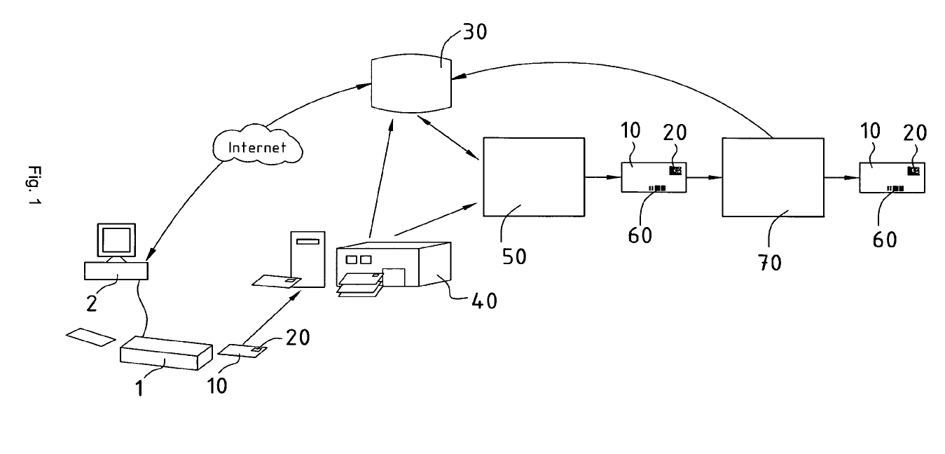

FIG. 1 shows a schematic diagram of a logistics system according to the invention. The logistics system allows a plurality of users to provide mailpieces with identification information and to drop off these mailpieces for physical transportation within the logistics system.

Of course, this also includes the case in which the mailpieces are only provided with the identification information at a later point in time—for instance, when they are dropped off or when they are detected.

An exemplary embodiment of the invention comprises the registration of the user.

The user is registered, for example, by entering the identification information and, if applicable, security features of the user in a database.

Registration of the user is especially advantageous if the user is to be provided with information about a plurality of mailpieces 10 that have been dropped off for him. Moreover, by having the user registered, the billing of transportation fees for the mailpieces 10 can be done in an especially simple and reliable manner.

Of course, however, it is likewise possible to carry out the method without registration of the user.

In this case, it is advantageous for the customer to enter identification information associated with the mailpiece 10 when requesting shipping information about the dropped-off mailpiece 10 from a server 30.

The codes are especially well-suited for a machine-readable depiction of franking information. Here, existing franking methods can be used as well as those that might be available in the future. Examples of exemplary embodiments of digital franking methods are the following digital franking methods of the Deutsche Post AG:
digital stamp,
eStamp,
franking service,
FRANKIT,
computer franking,
Infopost with premium address.

The codes can, however, also be used in a different manner as proof of payment of a transportation fee.

FIG. 1 shows a logistics system in which a mailpiece 10 is physically transported from an originating location to a destination. In this exemplary embodiment, the mailpiece 10 is depicted as a letter in order to simplify the representation. However, by the same token, this can obviously also be another kind of mailpiece, for example, a postcard or a parcel or any other object that can be transported within a logistics system.

In addition to the physical transportation of the mailpiece 10, information pertaining to the mailpiece is also transmitted.

This information is especially a data record with data for identifying the mailpiece.

The data record with the information for identifying the mailpiece can be generated at different places.

Thus, for example, it is possible to generate the data record with data for identifying the mailpiece in a user computer 2 and to apply it onto the mailpiece with a printer 1.

The applied information is preferably applied onto the mailpiece as a first machine-readable code 20.

An exemplary embodiment of the invention comprises informing the logistics system in advance about a mailpiece 10 that is going to be dropped off. This can be done, for example, in that the computer 2 of the user and a data transmission shipping system, for example, the Internet, are employed to transmit identification information about the mailpiece to the server 30.

However, by the same token, it is possible for the identification information to only be transmitted at the time when the mailpiece is dropped off at a drop-off location 40—for example, an appropriately equipped mailbox, a post office branch, a postal center, mail center or freight center, an electronic parcel deposit box facility, an electronic mailbox facility, a drop box at some other comparable facility.

Of course, it is likewise possible for the identification information to only be transmitted during a subsequent processing procedure of the mailpiece, for example, in a processing unit, for instance, a payment verification unit or a sorting machine.

In an exemplary embodiment of the invention, the mailpiece 10 is transported to a processing unit 50 between the time when the machine-readable code 20 was applied, for example, in the area of a user or at a drop-off location 40. The processing unit 50 is a device for processing mailpieces with at least one detector that is adapted to detect the first machine-readable code that was applied onto the mailpiece.

The device 50 contains a detector (not shown here for the sake of clarity) for detecting at least part of the machine-readable code. The detector may be, for example, an optical detection unit that is suited, for instance, for detecting modules of a data matrix code.

The device 50 also comprises a device—likewise not shown here for the sake of clarity—for providing the mailpiece with a second machine-readable code.

The device for providing the mailpiece with a second machine-readable code may be, for example, a printing unit, for example, a laser printer, an inkjet printer or a thermal transfer printer. However, it is likewise possible for the second code to be applied in that a sticker—if applicable printed separately—is applied onto the mailpiece 10.

Moreover, a link is established between the first code 20 and the second code 60. The link between the first code 20 and the second code 60 can be made in various ways.

Thus, it is possible, for instance, for the first code to be detected in an area of the device 50 and for the second code to be detected taking information contained in the first code, for example, identification information contained in the first code.

In this exemplary embodiment, it is possible, for example, to configure the second code in such a way that it and the first code comprise at least partially corresponding identification information.

In this case, it is possible to establish a link between the first code and the second code on the basis of the corresponding constituents of the identification information.

However, the invention also comprises exemplary embodiments in which the second code is generated independently of the detection of the first code.

In this case, it is advantageous to generate association information between the first code and the second code, for example, in a concordance list, a table or a database.

Before the second code 60 is applied, processing procedures of the mailpiece can be influenced by the first code 20.

Thus, for example, it is possible to check whether the first machine-readable code 20 contains information that serves as proof of payment for the mailpiece and furthermore, billing can be carried out on the basis of the first code.

If applicable, mailpieces for which the first code 20 does not contain any information about the payment of postage or no monetary value information can be diverted from the normal transportation process of the mailpieces.

This diverting procedure is carried out, for example, in a separate payment verification unit or, if applicable in a sorting device that is equipped with a detector that is adapted to detect the first code and with an evaluator that is adapted to evaluate code contents of the first code.

Moreover, it is also possible to carry out other processing procedures of the mailpiece on the basis of the first code and to use the code, for instance, for sorting and/or forwarding the mailpiece.

Via the detection of the first code, the user is informed about the transportation status of the mailpiece before the second code is applied.

For example, the first code 20 is detected at a drop-off location 40.

Moreover, it is possible for the first code 20 to be detected during the transportation to the device 50, for example, in a mode of transportation—such as a transportation vehicle—that is conveying the mailpiece from the drop-off location 40 to the device 50.

After the second code 60 has been applied, the mailpiece 10 can be processed and/or detected by detecting the first code 20 and/or the second code 60.

An exemplary embodiment of the invention provides that the first code 20 and the second code 60 are applied onto the mailpiece in different ways.

An exemplary embodiment of the invention provides that the first code 20 and the second code 60 are stored in different media.

In particular, an exemplary embodiment of the present invention comprises the fact that one of the two codes is stored in a transponder and that the other code is printed onto the mailpiece.

Thus, it is possible, for instance, for the mailpiece 10 to be provided with a transponder that contains the code 20 in machine-readable form.

In this example, processing and detection procedures of the mailpiece 10 are carried out through the electromagnetic detection of the contents of the transponder associated with the mailpiece—not shown here for the sake of clarity.

After the second code 60 has been applied, the mailpiece can be processed as desired, either on the basis of the first code 20 or on the basis of the second code 60. The information about the transportation status of the mailpiece can also be detected as desired, either on the basis of the first code 20 or on the basis of the second code 60.

Processing and/or checking the status of the mailpiece is carried out, for example, in the additional device 70 shown in FIG. 1. This device 70 can likewise be, for example, a mail processing unit.

The device 70 is located, for example, in another mail processing center that is preferably physically separated from a mail processing center where the device 70 is located.

In an exemplary embodiment of the invention, at least one of the codes is detected in the device 70.

The result of the detection of the code 60 is transmitted to the server 30 in at least one, preferably several or all of the following places, whereby, if applicable, the detected code 60 is transmitted via interconnected systems—especially different data processing systems, optionally in different countries—for instance,
when the first code is generated for example, when the mailpiece is printed by a printer of a user computer,
when the mailpiece is dropped off at a drop-off location 40,
in the device 50,
in the additional device 70,
in a mode of transportation for the transport of a mailpiece or
when the mailpiece is delivered to a recipient.

An exemplary embodiment of the invention, in which first the first code 20 is entered into a transponder and subsequently the mailpiece is provided with a second code in optically readable form—for example, by printing or gluing a label—is the transportation of mailpieces internationally.

In this exemplary embodiment, a postal service provider where processing and/or mailpiece detection procedures are carried out on the basis of information contained in the transponder preferably uses information acquired in its own processing stations by detecting the first code in order to transport or track mailpieces.

Subsequently, the mailpiece is transferred to another postal service provider, for example, by forwarding the mailpiece to a mail distribution center, for example, an international mail center, specially provided for forwarding mailpieces to foreign countries.

In an exemplary embodiment, the second machine-readable code is applied in the international mail center, especially in a device located there for processing mailpieces.

Then the mailpiece is further transported to the destination country. In the destination country, processing procedures of the mailpiece can be carried out or tracking of the mailpiece is carried out on the basis of the information contained in the second code 60.

If the second code 60 is present in a format that can be recognized by an optical detection device—for example, as a linear code or as a data matrix code—then this code can be detected by a machine at the second postal service provider using optical recognition for purposes of the transportation procedures or processing and shipping procedures.

However, the invention also comprises the case in which a mailpiece is first provided with a machine-readable code 20 in an optically recognizable form—for example, by printing onto the mailpiece or by gluing a shipping sticker onto the mailpiece.

In this exemplary embodiment, the second code is applied, for instance, in that a transponder is written or in that a transponder is connected to the mailpiece—for example, by gluing.

In this manner, it is possible for users of postal services to easily label a mailpiece themselves, for example, by printing the first code onto it, or else by applying stickers that contain the first code 20 onto the mailpiece.

In this case, the mailpiece is provided with the second code—which in this exemplary embodiment is or will be stored in a transponder—at a separate location, for example, at the drop-off location 40 or in the processing unit 50 that, if applicable, can also be situated in the area of the drop-off location 40.

There are several advantages to exemplary embodiments of the invention in which the user first applies an optically recognizable machine-readable code onto the mailpiece, and the mailpiece is provided with transponder information in a separate procedure, for example, when it is dropped off at a drop-off location.

Thus, it is possible for a user to apply the first code 20 to the mailpiece using existing infrastructure, especially the user computer 2 that is already on hand anyway and an available printer 1.

By providing the mailpiece with the information in the form of a second code that can be read out and/or written by radio frequency transmission, it is possible to carry out processing procedures of the mailpiece on the basis of the information contained in the transponder.

This exemplary embodiment is especially preferred if mailpieces are to be detected in an especially simple and reliable manner.

Moreover, by providing mailpieces with transponders and by storing codes in the transponders, it is possible to carry out processing procedures and/or detection procedures of the mailpiece by detecting the contents of the transponder.

If applicable, the contents of the transponders can be detected contact-free and at a distance from the mailpiece by using suitable reading devices.

In this manner, it is possible to considerably speed up the procedure of processing the mailpieces.

An exemplary embodiment of the server is characterized in that it is connected to an interface for entering shipment-relevant information.

The shipment-relevant information is, for example, sender data and/or recipient data.

Moreover, it is advantageous for the server to be connected to an interface for entering franking-relevant information.

Advantageously, the franking-relevant information contains specifications about the object—below also called the shipping product—and/or information about whether the shipping product
still has to be paid for or
has already been paid.

For the collection of mail items, it is a known procedure to employ collecting containers that are designed so that, when mail is dropped in, they allow the storage of the mailpieces and also prevent access to mail already in the box. When it comes to mailboxes, the insertion slot is normally configured to be so narrow that it is not possible to access the mail that has already been dropped in.

In the realm of the collection of larger mail items such as packages and parcels, it is also known procedure to employ containers to collect such items.

Large volumes of mail are advantageously dropped off at other suitable drop-off locations such as, for example, branch offices of the logistics system or directly in the area of the processing units of the logistics system.

The identification information of a mailpiece is read in.

The identification information is read in, for instance, in a mail center. A processing unit is used for reading in the identification information. It is possible to provide a dedicated processing unit for this, for example, a device that is suitable for checking the surfaces of mailpieces and/or for reading information contained in transponders.

However, it is likewise possible for the identification information of the mailpiece to be read in using a processing unit intended for other processing procedures of the mailpiece, for example, in a machine that sets the mail upright or in a machine that sorts the mail.

An exemplary form of the server is characterized in that it comprises:
at least one external connector for receiving a service request whose generation can be initiated in a server of a user, and for transmitting an ascertained processing result to the user computer,
internal connectors that are separate from the server. In particular, this also allows adaptations of internal connectors during ongoing operation of the server in that the external connector that is to be adapted is separated from the server, adapted and then once again connected to the server.

In an exemplary embodiment of the invention, the server comprises an authorization and authentication unit for checking the authorization of the user to access the data and information presented in this application text.

With the authorization and authentication unit, the authorization of a user can already be checked in the server. Moreover, the authorization to access several services of the service provider can be checked, so that a so-called single sign-on, i.e. a central authorization for several services, is made possible.

The invention comprises a logistics system for transporting a mailpiece on a transportation route within a postal distribution network, whereby the transportation route comprises several nodes of the postal distribution network, especially a node corresponding to a delivery point, as well as at least one node that corresponds to a sorting point.

The term logistics system encompasses especially systems that have the necessary methods and/or devices in order to transport mailpieces from an origination location to a delivery point on a transportation route within a postal distribution network.

An origination location is, for example, a warehouse location or a delivery location for the mailpiece that is to be transported.

The delivery point is preferably selected by the user.

In an exemplary embodiment of the invention, it is provided that the authorization of the user is checked on the basis of an authorization profile.

On the basis of the authorization profiles, especially on the basis of the user authorization profiles, the scope to which a user of the logistics system can make use of franking services of the service provider can advantageously be checked or determined. In this context, the authorization profile can be prescribed user-specifically, so that different authorizations for the use of a franking service can be granted to different users.

Preferably, the service request contains information that is encrypted with a key that is unambiguously associated with the Internet marketplace and that can be decrypted in the authorization and authentication unit.

On the basis of the encrypted information containing a key that is unambiguously associated with the user, the authenticity of the service request can be ascertained.

In another exemplary embodiment of the invention, it is provided for the user authorization profile to be contained in the service request.

By incorporating the user authorization profile into the service request, the scope to which the user can make use of franking services of the service provider can be indicated in the service request.

Preferably, it is provided that the user authorization profile is encrypted with a key that is unambiguously associated with the user or that is provided with a digital signature of the user.

In this manner, the authenticity of the user authorization profile can be checked in the server.

In another exemplary embodiment of the invention, it is provided that the authorization and authentication unit can modify the user authorization profile as a function of the processing result ascertained in the provider server.

In this manner, the authorization profile of a user can be modified as a function of the use of a specific franking service of the service provider.

Preferably, it is provided that the authorization and authentication unit can modify the user authorization profile as a function of a number of processing results ascertained for a user.

Numerous exemplary embodiments make it possible to check the authorization of the user to drop off shipments for transportation with the logistics system.

In another exemplary embodiment of the invention, it is provided for the server to have a reporting unit for acquiring and evaluating the service requests and the processing results.

Advantageous refinements of an exemplary embodiment of the present invention regarding the method correspond to the exemplary embodiments of the invention described in conjunction with the server.

Additional input possibilities are, for example, the written acquisition and later digitization, for example, by a service unit.

Preferably, the data is transmitted to the franking service via an interface in the form of a specified parameter set or according to a specific convention of a defined data record.

An exemplary embodiment of the invention is to be explained with reference to the embodiment of a server, which will be referred to below as the server.

In one case, the server is configured in such a way that users can access it via user computers.

A direct connection between the user computers and the server is not necessary, although possible.

In an exemplary embodiment, the user computers are connected to the server so that a data exchange between the computers and the server can take place directly.

The server can be accessed via the Internet, for example, on a website of the user, that is provided by the server and that is equipped with a browser program that is implemented in the user computers and displayed on a display of the user computers.

In an exemplary embodiment of the invention, the server comprises external connectors that are connected to the user computers via a communication network, preferably the Internet. The external connectors are inserted into the connector slots of the server.

Within the server, there is a connection between the external connectors and an authorization and authentication unit which, in turn, is in communication with a transformation unit. The authorization and authentication unit can be bridged for purposes of a direct data transmission between the external connectors and the transformation unit.

The transformation unit is connected to a checking unit which, in turn, is connected to the internal connectors. Here, too, a direct connection between the transformation unit and the internal connectors can be created in which the checking unit is bridged.

Moreover, the server comprises a controlling and reporting unit for administering the server and also for logging purposes.

The server can be configured as hardware or as software. In an exemplary embodiment of the invention, it is realized in the form of several software modules that are executed in an Internet server.

The request of the franking services is initiated directly or indirectly on a website, for example, by clicking on a button located on the website. In particular, websites that are displayed as a processing result or partial processing result during the performance of the service can, if applicable, be adapted by the server to the appearance of the websites in a simple manner.

In order to interconnect a plurality of users, the server has a plurality of connector slots to receive external connectors. Here, it is possible to plug and unplug external connectors during the ongoing operation of the server, thus ensuring uninterrupted operation of the server. In the case of changes that are made to an external connector, such a connector can likewise be unplugged, adapted and plugged in again in the activated state of the server, so that here as well, no interruption in the operation of the server is necessary.

A service request is received by the server at the external connector that is associated with the corresponding user and, if applicable, a format change of the above-mentioned type is made.

An external connector transmits the service request within the server to an authorization and authentication unit which first carries out an authentication step to check whether the user is fundamentally allowed to use the franking services of the service provider. Here, the authentication is carried out on the basis of the identity of the user.

The authentication is made on the basis of authentication information that is contained in the service request and whose authenticity is ensured by the use of cryptographic methods. Suitable cryptographic methods include, for example, digital signatures of the service request or of a part thereof. Likewise, it is possible for contents of the service request to be encrypted using a key (asymmetrical encryption with certified keys) that is associated with the Internet marketplace or with the user, or else using a symmetrical key (symmetrical encryption with “pre-shared key”) that is exchanged between the server and the Internet marketplace or the user ahead of time.

If a successful authentication is not possible, this means that it is not an authentic service request of the user of a registered Internet marketplace or else it means that, for other reasons, the user is not authorized to make use of franking services of the service provider. In this case, the authorization and authentication unit generates an error message that is transmitted via the external connector to the user computer. Moreover, logging of the service request can be provided by the controlling and reporting unit, which will be explained below.

After a successful authentication, the authorization and authentication unit carries out an authentication step to ascertain the authorization of the user to make use of the franking services. This procedure checks which franking services the user is allowed to make use of and to what extent. This is likewise done on the basis of the identity of the user.

The authorization of a user is carried out on the basis of a user authorization profile that is preferably stored in the authorization and authentication unit. The user authorization profile contains information about the scope to which the user can make use of franking services, i.e. which functions within the franking service can be executed by the user.

The authorization of a user is preferably carried out on the basis of a user authorization profile in the service request, which is likewise cryptographically secured. The user authorization profile is preferably incorporated into the service request by a server or by a script that is embedded into the website of the Internet marketplace, or else said user authorization profile is stored in the server in a database. The user authorization profile indicates the scope to which the user can make use of franking services of the service provider. In this manner, the users of the Internet marketplace can be provided with different access rights to the franking services of the service provider.

In order to carry out the authorization, the authorization and authentication unit checks on the basis of the user authorization profile whether and to what extent the user is authorized to make use of the franking service or services being requested. If this checking procedure shows that the user is not authorized to make use of the requested franking service or services, then preferably an error message is generated and transmitted via the external connector to the computer of the user.

The transformation unit receives the service request, if applicable, together with the ascertained authorization information, from the authorization and authentication unit. Depending on the content of the service request and if applicable on the authorization information ascertained in the authorization and authentication unit, the service request is converted by the transformation unit. Since, in contrast to the static format change that is made in the external connectors, the conversion is carried out as a function of the content of the service request, it is also referred to here as an intelligent conversion.

In the transformation unit, processes are carried out for purposes of the intelligent conversion and they allow the service request to be forwarded to the applicable service program executed on one of the provider servers. If several franking services are being requested with one service request, the service request or the applicable part thereof is forwarded to a provider server for each of the services in the manner described below.

In this process, the transformation unit carries out a so-called routing of the service request, in other words, depending on its content, the provider server is ascertained on which the service program for performing the requested franking service is executed, and the service request is addressed to this provider server. Furthermore, additional intelligent conversions are carried out such as, for example, a modification and augmentation of data contained in the service request.

The intelligent conversions can also be, for instance, corrections that arise after plausibility checks or after the application of parsing rules, i.e. of rules for the interpretation of the service request. If, for example, a franking service for producing address labels recognizes post office box information in a data field that is intended for designating the street name, then this can be corrected by the transformation unit.

By the same token, it is possible, within the scope of the intelligent conversion, to modify service requests in such a way that, instead of the requested franking service, a more up-to-date, improved or less expensive service is performed (for example, within the scope of a special campaign).

Moreover, in an exemplary embodiment of the invention, so-called dynamic routing is provided in which the availability of the provider servers is ascertained and the service request is addressed to a provider server whose availability has been ascertained. Moreover, it can also be provided that the transformation unit performs so-called load balancing in which, in addition to the availability, the load status of the server is also ascertained and the service request is transmitted to the provider server having the lowest load.

After the service request has been processed in the transformation unit, it is transmitted directly or via a checking unit to the internal connector that is connected to the ascertained provider server.

Moreover, in an exemplary embodiment of the invention, it is provided that, together with the service request, authentic additional information, for example, encrypted information, is transmitted from the transformation unit to the provider server. In this process, the additional information is decrypted in the provider server with a key that is unambiguously associated with the transformation unit or with the server, in order to check whether the service request has come from the server. In this exemplary embodiment of the invention, it is possible to dispense with an additional authorization and/or authentication of the marketplace user in the provider server.

The internal connectors are capable of making static format changes to the service program call and are connected to the server via connector slots into which internal connectors are plugged in during ongoing operation and from which internal connectors can be unplugged during ongoing operation.

Due to the mode of operation of the internal connectors, when the service programs are adapted to the provider servers, all that is needed is an adaptation of the connectors, but not an adaptation of the transformation unit. Moreover, such adaptations can also be made during ongoing operation of the server by unplugging the involved internal connectors during the adaptation.

The service request is transmitted to the ascertained provider server via the internal connectors. This is preferably done via a network like the Internet or—if the server is operated by the service provider itself—via an internal data network of the service provider.

After the service request has been processed in the service program executed on the provider server, that is to say, after the service has been performed, the provider server sends the processing result, i.e. the data ascertained in the provider server during the performance of the franking service or the execution of the service program, back to the server, where it is, in turn, received by the internal connector.

After the receipt and after the execution of any format changes that might need to be made within the internal connector, the processing result is transmitted to the checking unit, where the processing result is formally checked. In this process, it is checked whether the processing result is complete and formally correct. With an eye towards the completeness, for example, in case of a request for a digital postage indicium by a user, it is checked whether the processing result comprises an imprint or a print preview of the postage indicium. The criteria for the checking of the processing results of the various provider servers are stored in a database of the server.

If the processing result is either incomplete or incorrect, then, instead of the processing result or in addition to the processing result, a notification indicating the error is transmitted to the computer of the user.

The checking unit is also capable of checking the availability of the provider server and of informing the transformation unit about the result so that, on the basis of the checking results, the transformation unit can effectuate the described dynamic routing of the service requests.

The checked processing result is fed within the server either via the transformation unit or, by circumventing the transformation unit, to the external connectors that are connected to the Internet marketplace from which the service request originated.

Further processing of the processing result in the server is needed if an intelligent processing of the processing result is to be undertaken in addition to the forwarding of the processing result to the computer of the user or to a consolidator source.

The notification is generated in the transformation unit. The subject of the notification can be, for example, information indicating that a mailpiece has been transported or that it is on its way from A to B.

In this manner, the result of the service can also be transmitted from the dissemination source to the user computer.

After the optional processing of the processing result by the transformation unit, this processing result is either fed via the authorization and authentication unit or, by circumventing this unit, to the external connector that is connected to the Internet marketplace in question.

In an exemplary embodiment of the invention, it is provided that the user authorization profile can be modified in the authorization and authentication unit as a function of the processing result.

Thus, for example, it is possible to associate expanded authorizations with users who, within the scope of a “frequent user program”, frequently make use of a certain franking service, whereby for this purpose, the authorization and authentication unit ascertains the number of processing results transmitted to a given user.

The external connector makes the requisite format changes that correspond to the format change during the processing of the service request in the external connector, or that is prescribed independently thereof. Furthermore, various format changes can be made to the processing result and to the notification to the dissemination source determined on the basis of the processing result.

Moreover, within the scope of a conversion of the processing result in the transformation unit or within the scope of the format change in the external connector, graphic adaptations can be made to the processing result so that it can be adapted to the appearance of the marketplace. This can especially be done if the processing result is a website containing certain information.

Finally, the external connector transmits the processing result to the computer of the user from whom the service request comes.

In order to administer and monitor the server, a controlling and reporting unit is provided that is operated by an administrator. One or more external data processing devices can be connected to the controlling and reporting unit for purposes of evaluating utilization data of the server.

The controlling and reporting unit can, on the one hand, define the rules for the format change in the external connectors and in the internal connectors, the rules for the authorization and authentication unit, the rules for the intelligent conversion in the transformation unit, as well as the criteria for checking the processing results in the checking unit. On the other hand, the controlling and reporting unit is capable of ascertaining the utilization of the server and of the connected provider servers by the users of the Internet marketplaces and to provide this in the form of access tables and statistics for evaluation and billing purposes. All of the administration and evaluation activities can also be carried out by the connected data processing devices.

Moreover, especially comparisons can be made between the point in time at which a service request is received in the server and the point in time at which the processing result is sent out by the server, so that, in this manner, it is possible to

ascertain a processing duration and to check compliance with availability commitments in individual cases as well as statistically. For this purpose, the necessary information for the evaluation is transmitted from the transformation unit to the controlling and reporting unit and evaluated there or in the data processing devices.

Furthermore, it is possible to draw up access lists and statistics about the use of the logistics services by the user.

The server is characterized in that
it comprises a device that is adapted to check the authorization of the user,
it has a receiver that is adapted to receive identifier information about the user, and
it has a memory unit for storing the identifier information in a positive list.

A refinement of the server provides that it is connected to an interface for entering shipment-relevant information.

A refinement of the invention provides for the server to be connected to an interface for entering franking-relevant information.

A refinement of the invention provides that a service request can be configured in such a way that
it either transmits only shipment-relevant data or
franking-relevant data without payment information or
franking-relevant data with payment information.

A refinement of the invention provides that the service request contains information that is encrypted with a key that is unambiguously associated with the user and that can be decrypted in the authorization and authentication unit.

A refinement of the invention provides that the user authorization profile is contained in the service request.

A refinement of the invention provides that the user authorization profile is encrypted with a key that is unambiguously associated with the user or that is provided with a digital signature of the user.

A refinement of the invention provides that the data transmitted to the franking service contains information from the user authorization profile.

A refinement of the invention provides that the service request is transmitted in the form of a parameter set and/or of a specific data syntax.

A refinement of the invention provides that, when the identifier information pertaining to shipping data is transmitted to the franking service, the postage value is automatically debited from an account of the buyer.

A refinement of the invention provides that the postage for the shipment is determined automatically.

A refinement of the invention provides that the postage for the shipment is determined as a function of the drop-off and/or sender address.

A refinement of the invention provides that the authorization of the user to access the franking service is checked.

A refinement of the invention provides that the authorization of the user to access a franking service is checked on the basis of a marketplace authorization profile associated with the user and/or on the basis of a user authorization profile associated with the user.

The invention especially provides that a franking or a franking-relevant transaction is requested via an operating unit, that this franking or transaction request is authenticated in a separate authorization unit, that the actual franking or franking-relevant transaction is controlled by the authorization unit, and that the result of the franking or of the transaction is transmitted back.

The invention has the additional advantage that, in the case of franking and other franking-relevant processes, additional authentication methods comprising, for example, biometric methods can be used.

Moreover, it is advantageous for the result of the transaction order to be transmitted to the authorization unit and for the authorization unit to transmit a message containing the result of the execution of the transaction order to the operating unit and/or to a printing unit.

The operating unit and the printing unit can be separate devices as well as a shared unit.

An example of separate devices is a personal computer and a printer that is connected to the personal computer, for example, directly or via a computer network.

A version of the operating unit and of the printing unit as a shared unit can consist, for example, of a franking unit configured according to the invention, for instance, a franking machine or another unit with at least one cryptographic module.

Another exemplary embodiment of the invention is characterized in that the franking unit sends the result of the execution of the transaction order to the authorization unit, and in that the authorization unit transmits to the operating unit and/or to a printing unit a message containing the result of the execution of the transaction order.

The invention provides an especially advantageous modular configuration of a franking system. In addition to the advantage of being able to develop and use identification information pertaining to the system and components independently of each other, there is the special advantage of an exceptional flexibility when the franking system is used by many users.

An exemplary embodiment of the invention is characterized in that the transaction request is transmitted from the operating unit to the authorization unit, in that the transaction request is authenticated in the authentication unit, and in that the authentication unit subsequently transmits an authenticated transaction order to the franking unit.

A special advantage of the inventive separation of the components in franking systems lies in the fact that a so-called cryptographic module can be used in which processes are carried out that increase the security of the generated postage indicia against fraud. This cryptographic module preferably consists of separate hardware and software. The task of this hardware and software is to store secret or other important data so that it is inaccessible and manipulation-proof, and also to perform cryptographic operations such as encryptions or signatures in a secure environment. Cryptographic modules of the type defined, for example, in the public standard FIPS 140-2 issued by the U.S. National Institute of Standards and Technology NIST (see www.nist.gov) are characterized in that any manipulation to the module is detected, resulting in the interruption of the operations and in the deletion of the contents, and, if applicable, even in the destruction of the module. It is only because a user of a modern franking system with fraudulent intent cannot influence or replicate the franking processes occurring in the cryptographic module that electronic franking systems can generate forgery-proof postage indicia.

In order to be able to use the functions of the cryptographic module especially efficiently, it is advantageous for the interfaces needed for purposes of user interaction in order to operate the franking system to be accommodated in a separate unit. In this manner, the operating unit and the franking unit, which consists of the cryptographic module, are separate from each other in modern franking systems with which forgery-proof postage indicia can be generated.

Another advantage of the separation of the operating unit and the franking unit lies in the fact that they can be physically separate, whereby the connection between the operating unit (user PC) and the franking unit (among others, the cryptographic module) is established via a data network.

The practical advantage of this physical separation of the operating unit and the franking unit lies in the fact that it is possible to generate forgery-proof postage indicia on a PC without the use of a cryptographic module running locally on the PC. Instead, the module is operated inexpensively in a central location and is used by all franking users on an as-needed basis.

Another advantage of the invention is that it allows the use of various methods for user authentication. In order to ensure that postage indicia with monetary value are only generated by authorized users, franking systems are generally configured with access security. In the simplest case, such security consists of a secret code that has to be entered when the system is activated. The method with the secret code is used, among other things, to protect electronic postage cancelling machines.

Moreover, it is advantageous to establish a pairing between the user identification and the user authorization. This is done, for example, by entering a user name (this serves for identification purposes) and a password (this serves for the authentication). The security is based on the fact that only the authorized user knows what the password is.

In addition to knowledge-based security, other authentication methods that either require the additional possession of an object or that are based on biometric features of the user are also suitable.

An authentication through the possession of an object is used, for example, in security systems that are based on microprocessor chip cards, so-called smart cards. Along the lines of a cryptographic module, data is stored or operations are carried out on a chip card that cannot be read out or manipulated. Since such cards cannot be forged or replicated, they can be used especially for secure identification. In addition to such an identification of the chip card, passwords or PINs (personal identification numbers) are regularly used for the authentication of the legitimate user.

Additional advantageous methods of authentication are based on reading out biometric features of the legitimate user. The objective is to scan unchangeable and unique biometric features—for example, fingerprints or iris patterns—in order to ascertain whether this is a legitimate user. Since the components of knowledge and possession can be dispensed with, biometric methods are considered to be especially simple, secure and thus future-oriented authentication methods.

According to the invention, additional information can be used for purposes of identification and authentication.

For example, it is advantageous to use an account number of a postage account from which postage values can be replenished as the identification feature.

The access to the postage account is authenticated, for example, by entering a password.

The information for the identification and authentication is used in the authorization unit to use the account number to select the appropriate postage account in a secure cryptographic module and to activate it with the password. Whereas the account number has to be visible on the “outside” of the cryptographic module as the identifying feature, the password is checked inside the cryptographic module. The checking takes place inside the module since the entered password (or an image of the password) is compared to a stored password (or to its corresponding image). In order to prevent third parties from reading out the stored password (or its image), the storage is carried out inside the cryptographic module of the franking unit.

The authorization unit and/or the user are advantageously authenticated in the cryptographic module of the franking unit.

It is advantageous to use this authentication for authorizations for generating postage indicia and/or for accesses to information about the mailpiece.

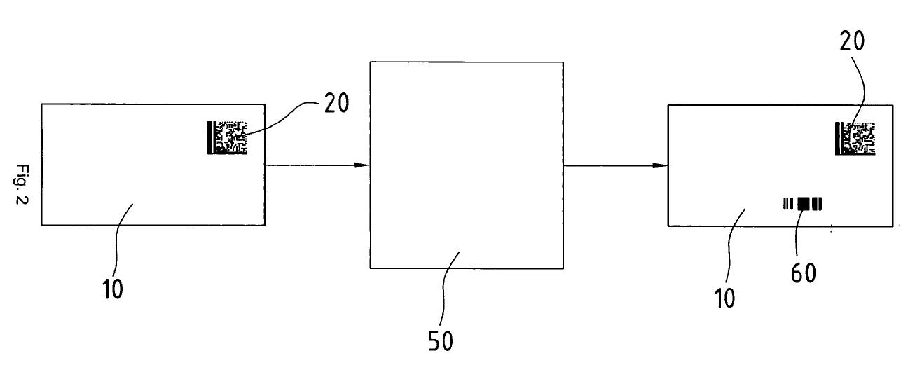

When cryptographically secured postage indicia are used, it is especially advantageous to use them for payment assurance and/or billing for the mailpiece—especially in the area of the first processing unit 50. A schematic representation of the processing unit 50 can be found in FIG. 2.

### LIST OF REFERENCE NUMERALS

1 printer
2 user computer
10 mailpiece
20 first code
30 server
40 drop-off location
50 device, first processing unit
60 second code
70 device, second processing unit

1-38. (canceled)

39. A method for conveying a mailpiece, whereby a first machine-readable code is applied onto the mailpiece as a data matrix code or stored in a transponder, the method comprising:
detecting the machine-readable code by at least one reading unit;
applying a second machine-readable code onto the mailpiece as a linear code or storing the second machine-readable code in the transponder;
storing information about a link between the first code and the second code in a data processing system;
receiving a service request; and
depending on content of the service request, converting the service request and forwarding it to a provider server for a service.

40. The method recited in claim 39, wherein the first code contains identification information.

41. The method recited in claim 39, wherein the second code contains identification information.

42. The method recited in claim 39, wherein the first code and the second code are applied onto the mailpiece in separate processing procedures.

43. The method recited in claim 42, wherein the mailpiece is conveyed in the time between the application of the first code and the application of the second code.

44. The method recited in claim 39, wherein the first code contains an identifier that distinguishes it from the second code.

45. The method recited in claim 39, wherein the second code contains an identifier that distinguishes it from the first code.

46. The method recited in claim 39, wherein the first code is of a different code type than the second code.

47. The method recited in claim 39, wherein the first code is detected in a processing unit.

48. The method recited in claim 39, wherein the second code is detected in a processing unit.

49. The method recited in claim 39, wherein the first code is detected in a first processing unit and the second code is detected in a second processing unit, the first processing unit being different from the second processing unit.

50. The method recited in claim 39, wherein the first code and the second code are detected in a common processing unit.

51. The method recited in claim 50, wherein the first code and the second code are linked in the common processing unit, taking into account the detection of the first code and of the second code.

52. The method recited in claim 39, wherein the first code contains identification information, and wherein a data record with data for identifying the mailpiece is created or modified, taking into account the identification information.

53. The method recited in claim 39, wherein the first code is applied onto the mailpiece at an earlier point in time than the second code.

54. The method recited in claim 39, wherein the second code and the first code are applied onto the mailpiece at the same time.

55. The method recited in claim 14, wherein the second code is applied onto the mailpiece at an earlier point in time than the first code.

56. The method recited in claim 39, wherein the data record with data for identifying the mailpiece is created or modified when the mailpiece is dropped off during the course of processing of mailpieces.

57. The method recited in claim 56, wherein the data record or at least part of it is made available to a user.

58. The method recited in claim 56, wherein the data record is stored on a server.

59. The method recited in claim 39, wherein the data record is linked to information about the conveyance status of the mailpiece.

60. The method recited in claim 59, wherein the conveyance status of the mailpiece is ascertained, taking into account the detection of the first code.

61. The method recited in claim 59, wherein the conveyance status is ascertained, taking into account the detection of the second code.

62. The method recited in claim 59, wherein the conveyance status is ascertained, taking into account the link between the first code and the second code.

63. The method recited in claim 39, wherein the first code can be detected by a first detection modality, and in that the second code can be detected by a different second detection modality.

64. The method recited in claim 63, wherein one of the detection modalities comprises the detection of graphically depictable code constituents.

65. The method recited in claim 63, wherein one of the detection modalities comprises the detection of transponder signals.

66. A device for processing mailpieces, comprising:
a detector that is adapted to detect at least part of a first machine-readable code that has been applied onto a mailpiece;
an applier that is adapted to apply a second machine-readable code onto the mailpiece;
an associator that is adapted to allow a linking of the first code to the second code; and
an interface that is adapted to transmit the linking information to a server.

67. A logistics system that is adapted to transport a mailpiece from an originating location to a destination, the logistics system comprising:
a conveyor that is adapted to convey the mailpiece to a device, the device comprising:
a detector that is adapted to detect at least part of a first machine-readable code; and
a applier that is adapted to apply a second machine-readable code onto the mailpiece;
an associator that is adapted to allow a linking of the first code to the second code;
a server that is adapted to provide a data record for the identification of the mailpiece and/or information about a conveyance status of the mailpiece; and
a transformation unit that is adapted to convert a service request that can be forwarded by the server to a provider server.

68. The logistics system recited in claim 67, comprising at least one device for processing mailpieces, the device comprising:
a detector that is adapted to detect at least part of a first machine-readable code that has been applied onto a mailpiece;
an applier that is adapted to apply a second machine-readable code onto the mailpiece;
an associator that is adapted to allow a linking of the first code to the second code; and
an interface that is adapted to transmit the linking information to a server.

69. The logistics system recited in claim 67, comprising a plurality of devices that each include a detector that is adapted to detect the first code and/or the second code, wherein the server includes a receiver that is adapted to receive information from the devices.

70. The logistics system recited in claim 67, comprising:
a first device that includes a detector that is adapted to detect at least part of the first machine-readable code;
a second device that is adapted to detect at least part of the second machine-readable code; and
wherein the server includes a receiver that is adapted to receive information from the first device and to receive information from the second device.

71. The logistics system recited in claim 67, comprising:
a storage device that is adapted to store a link between information about the first machine-readable code and the second machine-readable code; and
a provider of information about the mailpiece, taking into account this link.

72. The logistics system recited in claim 67, comprising at least two transport segments, wherein the first code is detected with a first detection modality in one transport segment, and wherein the second code is detected with a second detection modality in another transport segment.
